(19) United States
(12) Patent Application Publication
(10) Pub. No.: US 2006/0059118 A1
(43) Pub. Date: Mar. 16, 2006

(54) Apparatus, system, and method for associating resources using a behavior based algorithm

(76) Inventors: Stephen A. Byrd, San Jose, CA (US); Steven Czerwinski, Berkeley, CA (US); J. Kristofer Fox, San Luis Obispo, CA (US); Bruce Light Hillsberg, San Carlos, CA (US); Bernhard Julius Klingenberg, Morgan Hill, CA (US); Rajesh Francisco Krishnan, San Jose, CA (US); Balaji Thirumalai, Newark, CA (US)

Correspondence Address: KUNZLER & ASSOCIATES, 8 EAST BROADWAY, SUITE 600, SALT LAKE CITY, UT, 84111, US

(21) Appl. No.: 10/914,866

(22) Filed: Aug. 10, 2004

(51) Int. Cl. G06F 17/30

(52) U.S. Cl. 707/3

(57) ABSTRACT

An apparatus, system, and method are provided for associating resources using a behavior based algorithm. The apparatus comprises an initialization module, a query module, and a resource behavior module. The initialization module receives a seed identifier that identifies a seed resource. The seed resource may be a data file, an executable, file, a directory, or another data structure associated with a logical application or business process. The query module accesses trace data and searches the trace data for a candidate resource that might be linked to the seed resource. The trace data describes a plurality of resource events that occur on a computer or network system. The resource behavior module is configured to select a candidate resource based on a common resource event recorded in the trace data. The common resource event is an operation that involves both the seed resource and the candidate resource. Based on the common resource event, the candidate resource may be associated or linked with the seed resource. Together the seed resource and one or more linked resources may form a resource group, which may be associated with a particular logical application or business process.

### BACKGROUND OF THE INVENTION

1. Field of the Invention

The invention relates to data analysis and resource associations. Specifically, the invention relates to apparatus, systems, and methods for associating system resources using an algorithm based on behavior of the resources.

2. Description of the Related Art

Computer and information technology continues to progress and grow in its capabilities and complexity. In particular, software applications have evolved from single monolithic programs to many hundreds or thousands of object-oriented components that can execute on a single machine or distributed across many computer systems on a network.

Computer software and its associated data is generally stored in persistent storage organized according to some format such as a file. Generally, the file is stored in persistent storage such as a Direct Access Storage Device (DASD, i.e., a number of hard drives). Even large database management systems employ some form of files to store the data and potentially the object code for executing the database management system.

Business owners, executives, managers, administrators, and the like concentrate on providing products and/or services in a cost-effective and efficient manner. These business executives recognize the efficiency and advantages software applications can provide. Consequently, business people factor in the business software applications in long range planning and policy making to ensure that the business remains competitive in the market place.

Instead of concerning themselves with details such as the architecture and files defining a software application, business people are concerned with business processes. Business processes are internal and external services provided by the business. More and more of these business processes are provided at least in part by one or more software applications. One example of a business process is internal communication among employees. Often this business process is implemented largely by an email software application. The email software application may include a plurality of separate executable software components such as clients, a server, a Database Management System (DBMS), and the like.

Generally, business people manage and lead most effectively when they focus on business processes instead of working with confusing and complicated details about how a business process is implemented. Unfortunately, the relationship between a business process policy and its implementation is often undefined, particularly in large corporations. Consequently, the affects of the business policy must be researched and explained so that the burden imposed by the business process policy can be accurately compared against the expected benefit. This may mean that computer systems, files, and services affected by the business policy must be identified.

FIG. 1 illustrates a conventional system 100 for implementing a business process. The business process may be any business process. Examples of business processes that rely heavily on software applications include an automated telephone and/or Internet retail sales system (web storefront), an email system, an inventory control system, an assembly line control system, and the like.

Generally, a business process is simple and clearly defined. Often, however, the business process is implemented using a variety of cooperating software applications comprising various executable files, data files, clients, servers, agents, daemons/services, and the like from a variety of vendors. These software applications are generally distributed across multiple computer platforms.

In the example system 100, an E-commerce website is illustrated with components executing on a client 102, a web server 104, an application server 106, and a DBMS 108. To meet system 100 requirements, developers write a servlet 110 and applet 112 provided by the web server 104, one or more business objects 114 on the application server 106, and one or more database tables 116 in the DBMS 108. These separate software components interact to provide the E-commerce website.

As mentioned above, each software component originates from, or uses, one or more files 118 that store executable object code. Similarly, data files 120 store data used by the software components. The data files 120 may store configuration settings, user data, system data, database rows and columns, or the like.

Together, these files 118, 120 constitute resources required to implement the business process. In addition, resources may include Graphical User Interface (GUI) icons and graphics, static web pages, web services, web servers, general servers, and other resources accessible on other computer systems (networked or independent) using Uniform Resource Locators (URLs) or other addressing methods. Collectively, all of these various resources are required in order to implement all aspects of the business process. As used herein, “resource(s)” refers to all files containing object code or data as well as software modules used by the one or more software applications and components to perform the functions of the business process.

Generally, each of the files 118, 120 is stored on a storage device 122a-c identified by either a physical or virtual device or volume. The files 118, 120 are managed by separate file systems (FS) 124a-c corresponding to each of the platforms 104, 106, 108.

Suppose a business manager wants to implement a business level policy 126 regarding the E-commerce website. The policy 126 may simply state: “Backup the E-commerce site once a week.” Of course, other business level policies may also be implemented with regard to the E-commerce website. For example, a load balancing policy, a software migration policy, a software upgrade policy, and other similar business policies can be defined for the business process at the business process level.

Such business level policies are clear and concise. However, implementing the policies can be very labor intensive, error prone, and difficult. Generally, there are two approaches for implementing the backup policy 126. The first is to backup all the data on each device or volume 122a-c. However, such an approach backs up files unrelated to the particular business process when the device 122a-c is shared among a plurality of business processes. Certain other business policies may require more frequent backups for other files on the volume 122a-c related to other business processes. Consequently, the policies conflict and may result in wasted backup storage space and/or duplicate backup data. In addition, the time required to perform a full copy of the devices 122a-c may interfere with other business processes and unnecessarily prolong the process.

The second approach is to identify which files on the devices 122a-c are used by, affiliated with, or otherwise comprise the business process. Unfortunately, there is not an automatic process for determining what all the resources are that are used by the business process, especially business processes that are distributed across multiple systems. Certain logical rules can be defined to assist in this manual process. But, these rules are often rigid and limited in their ability to accurately identify all the resources. For example, such rules will likely miss references to a file on a remote server by a URL during execution of an infrequent feature of the business process. Alternatively, devices 122a-c may be dedicated to software and data files for a particular process. This approach, however, may result in wasted unused space on the devices 122a-c and may be unworkable in a distributed system.

Generally, a computer system administrator must interpret the business level policy 126 and determine which files 118, 120 must be included to implement the policy 126. The administrator may browse the various file systems 124a-c, consult user manuals, search registry databases, and rely on his/her own experience and knowledge to generate a list of the appropriate files 118, 120.

In FIG. 1, one implementation 128 illustrates the results of this manual, labor-intensive, and tedious process. Such a process is very costly due to the time required not only to create the list originally, but also to continually maintain the list as various software components of the business process are upgraded and modified. In addition, the manual process is susceptible to human error. The administrator may unintentionally omit certain files 118, 120.

The implementation 128 includes both object code files 118 (i.e., e-commerce.exe. Also referred to as executables) and data files 120 (i.e., e-comdata1.db). However, due to the manual nature of the process and storage space concerns, efforts may be concentrated on the data files 120 and data specific resources. The data files 120 may be further limited to strictly critical data files 120 such as database files. Consequently, other important files, such as executables and user configuration and system-specific setting files, may not be included in the implementation 128. Alternatively, user data, such as word processing documents, may also be missed because the data is stored in an unknown or unpredictable location on the devices 122a-c.

Other solutions for grouping resources used by a business process have limitations. One solution is for each software application that is installed to report to a central repository which resources the application uses. However, this places the burden of tracking and listing the resources on the developers who write and maintain the software applications. Again, the developers may accidentally exclude certain files. In addition, such reporting is generally done only during the installation. Consequently, data files created after that time may be stored in unpredictable locations on a device 122a-c.

Accordingly, a need exists for an apparatus, system, and method for associating resources with one another using a behavior based algorithm. The apparatus, system, and method should search all of the trace data associated with a business process or the entire system and select candidate resources that are anticipated to be related to a seed resource based on a common resource event. In addition, the apparatus, system, and method should select directories, data files, and executable files, as well as other system resources, based on the recorded interaction among such resources.

### SUMMARY OF THE INVENTION

The present invention has been developed in response to the present state of the art, and in particular, in response to the problems and needs in the art that have not yet been met for associating resources using a behavior based algorithm. Accordingly, the present invention has been developed to provide an apparatus, system, and method for associating resources using a behavior based algorithm that overcomes many or all of the above-discussed shortcomings in the art.

An apparatus according to the present invention includes an initialization module, a query module, and a resource behavior module. The initialization module receives a seed identifier that identifies a seed resource, such as an executable file. Certain operations involving the seed resource are recorded in trace data that describes a plurality of resource events.

In one embodiment, the initialization module may receive a seed identifier from a user, such as a system administrator via a user interface, or from a client application. The seed identifier may comprise the name of an executable file or a data file.

The query module is configured to search the trace data for a candidate resource that might be associated with the seed resource, such as in a logical application or business process. In certain embodiments, the query module may search for all resource events involving the seed resource. In other embodiments, the query module may search for only those resource events that involve the seed resource and a particular event type, such as a read or write operation.

The resource behavior module, in one embodiment, is configured to select a candidate resource based on a common resource event that involves both the seed resource and the candidate resource. For example, the common resource event may be defined by a file access where the seed resource accesses or is accessed by the candidate resource. In a further embodiment, the resource behavior module is also configured to link or associate the candidate resource with the seed resource. For example, the resource behavior module may create or update a resource group record that includes the seed identifier and one or more resource identifiers.

In certain embodiments, the query module and the resource behavior module may be employed either sequentially or iteratively to identify and select candidate resources. For example, after the resource behavior module links the candidate resource to the seed resource, the query module may subsequently use the newly linked resource to search for additional candidate resources that may be directly or indirectly associated with the original seed resource.

The resource behavior module, in one embodiment, may comprise a directory relationship module, a file relationship module, and an executable relationship module. The directory relationship module may further comprise a voting module and an index module.

In one embodiment, the directory relationship module is configured to determine if a directory is a candidate resource. The voting module may maintain one or more counters and the index module may establish an index. The index, when compared to a threshold, may be used to determine if the directory should be linked to the seed resource. A directory, and its parent directories, may be linked to the seed resource if files within the directory are accessed by the seed resource or another related resource. In one embodiment, the determination to link a directory may depend in part on the frequency of directory access. In a further embodiment, the determination not to link a directory may depend in part on the frequency or quantity of directory accesses by unrelated resources.

The file relationship module may be configured to determine if a certain file should be linked to the seed resource. In one embodiment, the determination to link a candidate file may depend on whether the seed resource or another linked resource accesses the candidate file. In a related manner, the executable relationship module may determine if an executable file should be linked to the seed resource. In one embodiment, the determination to link a candidate executable file may depend on whether the candidate executable file accesses the seed resource or another resource linked to the seed resource. In a further embodiment, the file relationship module and the executable relationship module may be iteratively invoked until the resource group of linked resources reaches a relatively steady state.

A method of the present invention is also presented for associating resources using a behavior based algorithm. In one embodiment, the method includes receiving a seed identifier corresponding to a seed resource, searching the trace data for a candidate resource, and selecting the candidate resource based on a common resource event involving the seed resource and the candidate resource. In further embodiments, the method also may include linking the candidate resource with the seed resource to form a resource group, determining if a directory is a candidate resource, determining if a file is a candidate resource, and/or relating the resource group to a logical application or business process.

The present invention also includes embodiments arranged as a system, machine-readable instructions, and an apparatus that comprise substantially the same functionality as the components and steps described above in relation to the apparatus and method. The features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating one example of how a business level policy may be conventionally implemented;

FIG. 2 is a logical block diagram illustrating one embodiment of an apparatus for automatically discovering and grouping resources used by a logical application in accordance with the present invention;

FIG. 3 is a schematic block diagram illustrating in detail sub-components of one embodiment of the present invention;

FIG. 4 is a schematic block diagram illustrating an example of a relational analysis apparatus of one embodiment of the present invention;

FIG. 4a is a schematic block diagram illustrating an example of a file association relationship utilized by a subcomponent of the relational analysis module;

FIG. 4b is a schematic block diagram illustrating an example of an executable association relationship utilized by a subcomponent of the relational analysis module;

FIG. 5 is a schematic block diagram illustrating a resource relationship tree in accordance with the present invention;

FIG. 6 is a schematic block diagram of a directory voting record according to one embodiment the present invention;

FIG. 7 is a schematic block diagram of a resource group record according to one embodiment of the present invention;

FIG. 8 is a schematic flow chart diagram illustrating one embodiment of a directory association method in accordance with the present invention;

FIG. 9 is a schematic flow chart diagram illustrating one embodiment of a directory voting method in accordance with the present invention;

FIG. 10 is a schematic flow chart diagram illustrating one embodiment of a file usage method in accordance with the present invention;

FIG. 11 is a schematic flow chart diagram illustrating one embodiment of a file association method in accordance with the present invention; and

FIG. 12 is a schematic flow chart diagram illustrating one embodiment of an executable association method in accordance with the present invention.

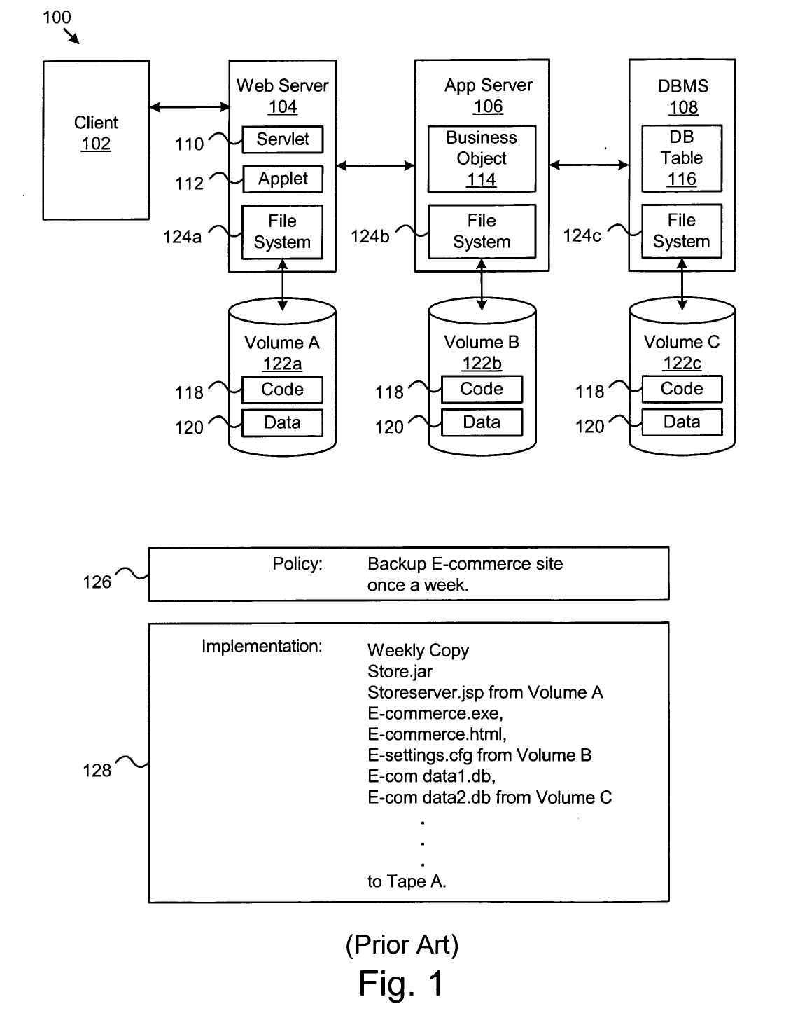

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the apparatus, system, and method of the present invention, as presented in the Figures, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, function, or other construct. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, software modules, user selections, user interfaces, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

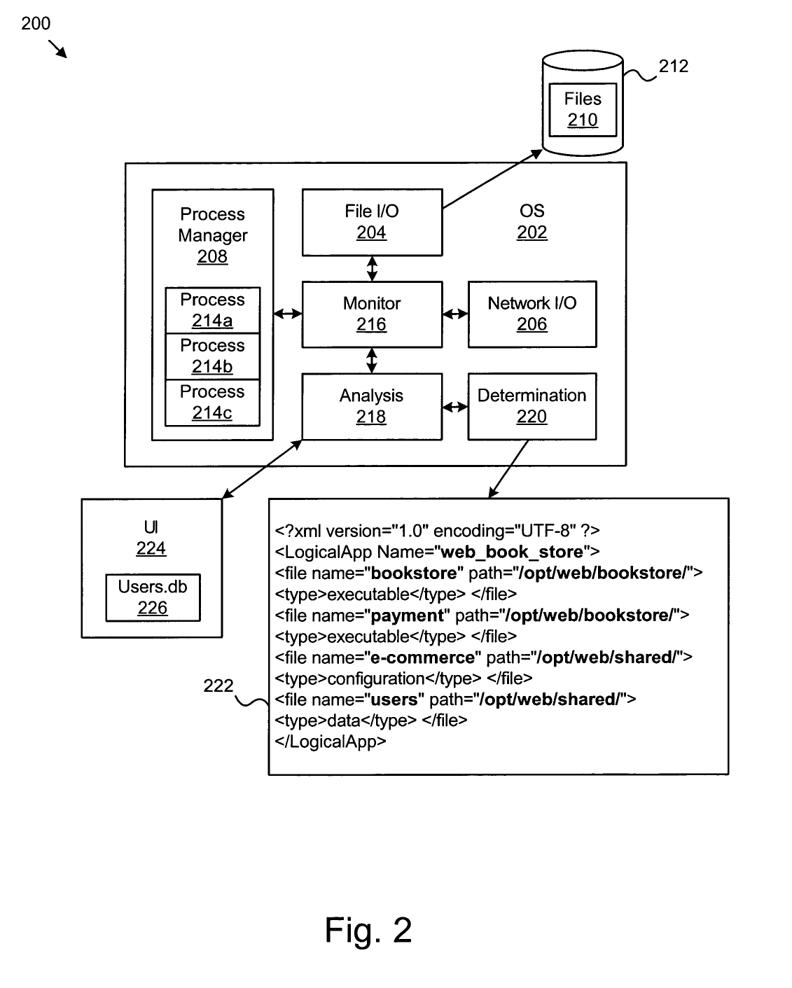

FIG. 2 illustrates a logical block diagram of an apparatus 200 configured to automatically discover and group files used by a logical application which may also correspond to a business process. A business process may be executed by a wide array of hardware and software components configured to cooperate to provide the desired business services (i.e., email services, retail web storefront, inventory management, etc.). For clarity, certain well-known hardware and software components are omitted from FIG. 2.

The apparatus 200 may include an operating system 202 that provides general computing services through a file I/O module 204, network I/O module 206, and process manager 208. The file I/O module 204 manages low-level reading and writing of data to and from files 210 stored on a storage device 212, such as a hard drive. Of course, the storage device 212 may also comprise a storage subsystem such as various types of DASD systems. The network module 206 manages network communications between processes 214 executing on the apparatus 200 and external computer systems accessible via a network (not shown). Preferably, the file I/O module 204 and network module 206 are modules provided by the operating system 202 for use by all processes 214a-c. Alternatively, custom file I/O module 204 and network modules 206 may be written where an operating system 202 does not provide these modules.

The operating system 202 includes a process manager 208 that schedules use of one or more processors (not shown) by the processes 214a-c. The process manager 208 includes certain information about the executing processes 214a-c. In one embodiment, the information includes a process ID, a process name, a process owner (the user that initiated the process), process relation (how a process relates to other executing processes, i.e., child, parent, sibling), other resources in use (open files or network ports), and the like.

Typically, the business process is defined by one or more currently executing processes 214a-c. Each process 214 includes either an executable file 210 or a parent process which initially creates the process 214. Information provided by the process manager 208 enables identification of the original files 210 for the executing processes 214a-c, discussed in more detail below.

In certain embodiments, the apparatus 200 includes a monitoring module 216, analysis module 218, and determination module 220. These modules 216, 218, 220 cooperate to dynamically identify the resources that comprise a logical application that corresponds to the business process. Typically, these resources are files 210. Alternatively, the resources may be other software resources (servers, daemons, etc.) identifiable by a network address such as a URL or IP address.

In this manner, operations can be performed on the files 210 and other resources of a logical application (business process) without the tedious, labor intensive, error prone process of manually identifying these resources. These operations include implementing business level policies such as policies for backup, recovery, server load management, migration, and the like.

The monitoring module 216 communicates with the process manager 208, file I/O module 204, and network I/O module 206 to collect trace data. The trace data is any data indicative of operational behavior of a software application (as used herein “application” refers to a single process and “logical application” refers to a collection of one or more processes that together implement a business process). Trace data may be identifiable both during execution of a software application or after initial execution of a software application. Certain trace data may also be identifiable after the initial installation of a software application. For example, software applications referred to as installation programs can create trace data simply by creating new files in a specific directory.

Preferably, the monitoring module 216 collects trace data for all processes 214a-c. In one embodiment, the monitoring module 216 collects trace data based on an identifier (discussed in more detail below) known to directly relate to a resource implementing the business process. Alternatively, the monitoring module 216 may collect trace data for all the resources of an apparatus 200 without distinguishing based on an identifier.

In one embodiment, the monitoring module 216 communicates with the process manager 208 to collect trace data relating to processes 214 currently executing. The trace data collected represents processes 214a-c executing at a specific point in time. Because the set of executing processes 214a-c can change relatively frequently, the monitoring module 216 may periodically collect trace data from the process manager 208. Preferably, a user-configurable setting determines when the monitoring module 216 collects trace data from the process manager 208.

The monitoring module 216 also communicates with the file I/O module 204 and network module 206 to collect trace data. The file I/O module 204 maintains information about file access operations including reads, writes, and updates. From the file I/O module, the monitoring module 216 collects trace data relating to current execution of processes 214 as well as historical operation of processes 214.

Trace data collected from the file I/O module 204 may include information such as file name, file directory structure, file size, file owner/creator, file access rights, file creation date, file modification date, file type, file access timestamp, what type of file operation was performed (read, write, update), and the like. In one embodiment, the monitoring module 216 may also determine which files 210 are currently open by executing processes 214. In certain embodiments, the monitoring module 216 collects trace data from a file I/O module 204 for one or more file systems across a plurality of storage devices 212.

As mentioned above, the monitoring module 216 may collect trace data for all files 210 of a file system or only files and directories clearly related to an identifier. The identifier and/or resources presently included in a logical application may be used to determine which trace data is collected from a file system.

The monitoring module 216 collects trace data from the network I/O module 206 relating to network activity by the processes 214a-c. Certain network activity may be clearly related to specific processes 214 and/or files 210. Preferably, the network I/O module 206 provides trace data that associates one or more processes 214 with specific network activity. A process 214 conducting network activity is identified, and the resource that initiated the process 214 is thereby also identified.

Trace data from the network I/O module 206 may indicate which process 214 has opened specific ports for conducting network communications. The monitoring module 216 may collect trace data for well-known ports which are used by processes 214 to perform standard network communications. The trace data may identify the port number and the process 214 that opened the port. Often only a single, unique process uses a particular network port.

For example, communications over port eighty may be used to identify a web server on the apparatus 200. From the trace data, the web server process and executable file may be identified. Other well-known ports include twenty for FTP data, twenty-one for FTP control messages, twenty-three for telnet, fifty-three for a Domain Name Server, one hundred and ten for POP3 email, etc.

In certain operating systems 202, such as UNIX and LINUX, network I/O trace data is stored in a separate directory. In other operating systems 202 the trace data is collected using services or daemons executing in the background managing the network

In one embodiment, the monitoring module 216 autonomously communicates with the process manager 208, file I/O module 204, and network I/O module 206 to collect trace data. As mentioned, the monitoring module 216 may collect different types of trace data according to different user-configurable periodic cycles. When not collecting trace data, the monitoring module 216 may “sleep” as an executing process until the time comes to resume trace data collection. Alternatively, the monitoring module 216 may execute in response to a user command or command from another process.

The monitoring module 216 collects and preferably formats the trace data into a common format. In one embodiment, the format is in one or more XML files. The trace data may be stored on the storage device 212 or sent to a central repository such as a database for subsequent review.

The analysis module 218 analyzes the trace data to discover resources that are affiliated with a business process. Because the trace data is collected according to operations of software components implementing the business process, the trace data directly or indirectly identifies resources required to perform the services of the business process. By identifying the resources that comprise a business process, business management policies can be implemented for the business process as a whole. In this way, business policies are much simpler to implement and more cost effective.

In one embodiment, the analysis module 218 applies a plurality of heuristic routines to determine which resources are most likely associated with a particular logical application and the business process represented by the logical application. The heuristic routines are discussed in more detail below. Certain heuristic routines establish an association between a resource and the logical application with more certainty than others. In one embodiment, a user may adjust the confidence level used to determine whether a candidate resource is included within the logical application. This confidence level may be adjusted for each heuristic routine individually and/or for the analysis module 218 as a whole.

The analysis module 218 provides the discovered resources to a determination module 220 which defines a logical application comprising the discovered resources. Preferably, the determination module 220 defines a structure 222 such as a list, table, software object, database, a text eXtended Markup Language (XML) file, or the like for recording associations between discovered resources and a particular logical application. As mentioned above, a logical application is a collection of resources required to implement all aspects of a particular business process.

The structure 222 includes a name for the logical application and a listing of all the discovered resources. Preferably, sufficient attributes about each discovered resource are included such that business policies can be implemented with the resources. Attributes such as the name, location, and type of resource are provided.

In addition, the structure 222 may include a frequency rating indicative of how often the resource is employed by the business process. In certain business processes this frequency rating may be indicative of the importance of the resource. In addition, a confidence value determined by the analysis module 218 may be stored for each resource.

The confidence level may indicate how likely the analysis module 218 has determined that this resource is properly associated with the given logical application. In one embodiment, this confidence level is represented by a probability percentage. For certain resources, the structure 222 may include information such as a URL or server name that includes resources used by the business process but not directly accessible to the analysis module 218.

Preferably, the analysis module 218 cooperates with the determination module 220 to define a logical application based on an identifier for the business process. In this manner, the analysis module 218 can use the identifier to filter the trace data to a set more likely to include resources directly related to a business process of interest. Alternatively, the analysis module 218 may employ certain routines or algorithms to propose certain logical applications based on clear evidence of relatedness from the trace data as a whole without a pre-defined identifier.

A user interface (UI) 224 may be provided so that a user can provide the identifier to the analysis module 218. The identifier 226 may comprise one of several types of identifiers including a file name for an executable or data file, file name or process ID for an executing process, a port number, a directory, and the like. The resource identified by the identifier 226 may be considered a seed resource for the logical application, as the resource identified by the identifier 226 is included in the logical application by default and is used to add additional resources discovered by searching the trace data.

For example, a user may desire to create a logical application according to which processes accessed the data base file “Users.db.” In the UI 224, the user enters the file name users.db. The analysis module 218 then searches the trace data for processes that opened or closed the users.db file. Heuristic routines are applied to any candidate resources identified, and the result set of resources is presented to the user in the UI 224.

The result set includes the same information as in the structure 222. The UI 224 may also allow the user to modify the contents of the logical application by adding or removing certain resources. The user may then store a revised logical application in a human readable XML structure 222. In addition, the user may adjust confidence levels for the heuristic routines and the analysis module 218 overall.

In this manner, the apparatus 200 allows for creation of logical applications which correspond to business processes. The logical applications track information about resources that implement the business process to a sufficient level of detail that business level policies, such as backup, recovery, migration, and the like, may be easily implemented. Furthermore, logical application definitions can be readily adjusted and adapted as subsystems implementing a business process are upgraded, replaced, and modified. The logical application tracks business data as well as the processes/executables that operate on that business data. In this manner, business data is fully archivable for later use without costly conversion and data extraction procedures.

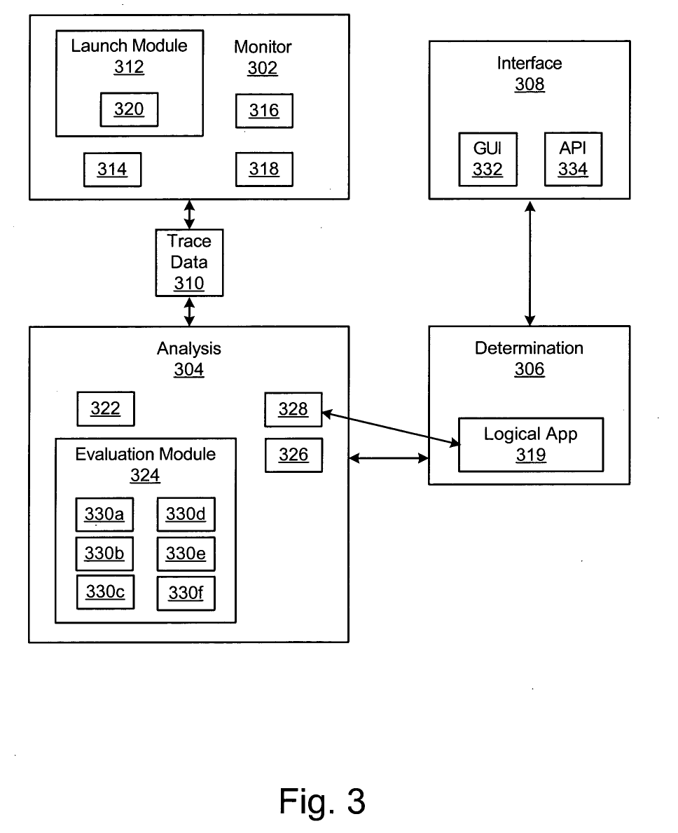

FIG. 3 illustrates more details of one embodiment of the present invention. This embodiment is similar to the apparatus 200 illustrated in FIG. 2. Specifically, the illustrated embodiment includes a monitoring module 302, analysis module 304, determination module 306, and interface 308.

In one embodiment, the monitoring module 302 collects trace data 310 as a business process is executing. In other words, the monitoring module 302 collects trace data as applications implementing the business process are executing. However, the monitoring module 302 may also collect sufficient trace data 310 when a business process is not being executed/operated. In addition, the interface 308 may receive an identifier that directly relates a resource implementing a business process to the business process. Preferably, the identifier is unique to the business process, although uniqueness may not always be required. This identifier may be used by the analysis module 304 in analyzing the trace data 310.

The monitoring module 302 includes a launch module 312, a controller 314, a storage module 316, and a scanner 318. The launch module 312 initiates one or more activity monitors 320. The launch module 312 may launch activity monitors 320 con when the monitoring module 302 starts or periodically according to monitoring schedules defined for each activity monitor 320 or for the monitoring module 302 as a whole.

An activity monitor 320 is a software function, thread, or application, configured to trace a specific type of activity relating to a resource. The activity monitor may gather the trace data by monitoring the activity directly or indirectly by gathering trace data from other modules such as the process manager 208, file I/O module 204, and network I/O module 206 described in relation to FIG. 2.

In one embodiment, each activity monitor 320 collects trace data for a specific type of activity. For example, a file I/O activity monitor 320 may communicate with a file I/O module 204 and capture all file I/O operations as well as contextual information, such as which process made the file I/O request, what type of request was made and when. One example of an activity monitor 320 that may be used with the present invention is a shim application described in U.S. patent application number ###, hereby incorporated by reference. Of course, various other types of activity monitors may be initiated depending on the nature of the activities performed by the business process. Certain activity monitors may trace Remote Procedure Calls (RPC).

The controller 314 controls the operation of the activity monitors 320 in one embodiment. The controller 314 may adjust the priorities for scheduling of the activity monitors to use a monitored system's processor(s). In this manner, the controller 314 allows monitoring to continue and the impact of monitoring to be dynamically adjusted as needed. The control and affect of the controller 314 on overall system performance is preferably user configurable.

The storage module 316 interacts with the activity monitors 320 to collect and store the trace data collected by each individual activity monitor 320. In certain embodiments, when an activity monitor 320 detects a resource (executable file, data file, or software module) conducting a specific type of activity, the activity monitor 320 provides the activity specific trace data to the storage module 316 for storage.

The storage module 316 may perform certain general formatting and organization to the trace data before storing the trace data. Preferably, trace data for all the activity monitors 320 is stored in a central repository such as a database or a log/trace file.

Typically, activity monitors 320 monitor dynamic activities performed during operation of a business process while the scanner 318 collects trace data from relatively static system information such as file system information, processes information, networking information, I/O information, and the like. The scanner 318 scans the system information for a specific type of activity performed by the business process.

For example, the scanner 318 may scan one or more file system directories for files created/owned by a particular resource. The resource may be named by the identifier such that it is known that this resource belongs to the logical application 319 that implements the business process. Consequently, the scanner 318 may provide any trace data found to the storage module 316 for storage.

In one embodiment, the monitoring module 302 produces a set or batch of trace data 310 that the analysis module 304 examines at a later time (batch mode). Alternatively, the monitoring module 302 may provide a stream of trace data 310 to the analysis module 304 which analyzes the trace data 310 as the trace data 310 is provided (streaming mode). Both modes are considered within the scope of the present invention.

The analysis module 304 may include a query module 322, an evaluation module 324, a discovery module 326, and a modification module 328. The evaluation module 324 and discovery module 326 work closely together to identify candidate resources to be associated with a logical application 319.

The evaluation module 324 applies one or more heuristic routines 330a-f to a set of trace data 310. Preferably, the query module 322 filters the trace data 310 to a smaller result set. Alternatively, the heuristic routines 330a-f are applied to all available trace data 310.

The filter may comprise an identifier directly associated with a business process. The identifier may be a resource name such as a file name. Alternatively, the filter may be based on time, activity, type, or other suitable criteria to reduce the size of the trace data 310. The filter may be generic or based on specific requirements of a particular heuristic routine 330a-f.

In one embodiment, the evaluation module 324 applies the heuristic routines 330a-f based on an identifier. The identifier provides a starting point for conducting the analysis of trace data. In one embodiment, an identifier known to be associated with the business process is automatically associated with the corresponding logical application 319. The identifier is a seed for determining which other resources are also associated with the logical application 319. The identifier may be a file name for a key executable file known to be involved in a particular business process.

Each heuristic routine 330a-f analyzes the trace data based on the identifier or a characteristic of a software application represented by the identifier. For example, the characteristic may comprise the fact that this software application always conducts network I/O over port 80. An example identifier may be the inventorystartup.exe which is the first application started when an inventory control system is initiated.

A heuristic routine 330a-f is an algorithm that examines trace data 310 in relation to an identifier and determines whether a resource found in the trace data 310 should be associated with a logical application. This determination is very complex and difficult because the single identifier provides such little information about the logical application 319. Consequently, heuristics are applied to provide as accurate of a determination as possible.

As used herein, the term “heuristic” means “a technique designed to solve a problem that ignores whether the solution is probably correct, but which usually produces a good solution or solves a simpler problem that contains or intersects with the solution of the more complex problem.” (See definition on the website www wikipedia org.).

In a preferred embodiment, an initial set of heuristic routines 330a-f is provided, and a user is permitted to add his/her own heuristic routines 330a-f. The heuristic routines 330a-f cooperate with the discovery module 326. Once a heuristic routine 330a-f identifies a resource associated with the logical application, the discovery module 326 discovers the resources and creates the association of the resource to the logical application.

One heuristic routine 330a identifies all resources that are used by child applications of the application identified by the identifier. Another heuristic routine 330b identifies all resources in the same directory as a resource identified by the identifier. Another heuristic routine 330c analyzes usage behavior of a directory and parent directories that store the resource identified by the identifier to identify whether the sub or parent directories and all their contents are associated with the logical application.

One heuristic routine 330d determines whether the resource identified by the identifier belongs to an installation package, and if so, all resources in the installation package are deemed to satisfy the heuristic routine 330d. Another heuristic routine 330e examines resources used in a time window centered on the start time for execution of a resource identified by the identifier. Resources used within the time window satisfy the heuristic routine 330e. Finally, one heuristic routine 330f may be satisfied by resources which meet user-defined rules. These rules may include or exclude certain resources based on site-specific procedures that exist at a computer facility.

In one embodiment, the evaluation module 324 cooperates with the discovery module 326 to discover resources according to two distinct methodologies. The first methodology is referred to as a build-up scheme. Under this methodology, the my heuristic routines 330a-f are applied to augment the set of resources currently within a set defining the logical application. In this manner, the initial resource identified by the identifier, the seed, grows into a network of associated resources as the heuristic routines 330a-f are applied. Use of this scheme represents confidence that the heuristic routines will not miss relevant resources, but runs the risk that some resources may be missed. However, this scheme may exclude unnecessary resources.

The second methodology, referred to as the whittle-down scheme, is more conservative but may include resources that are not actually associated with the logical application. The whittle-down scheme begins with a logical application comprising a pre-defined superset representing all resources that are accessible to the computer system(s) implementing the logical application, business process. The heuristic routines 330a-f are then applied using an inverse operation, meaning resources that satisfy a heuristic routine 330a-f are removed from the pre-defined superset.

Regardless of the methodology used, the evaluation module 324 produces a set of candidate resources which are communicated to the modification module 328. The modification module 328 communicates the candidate resources to the determination module 306 which adds or removes the candidate resources from the set defined in the logical application 319. The determination module 306 defines and re-defines the logical application 319 as indicated by the modification module 328.

Preferably, the evaluation module 324 is configured to apply the heuristic routines 330a-f for each resource presently included in the logical application 319. Consequently, the modification module 328 may also determine whether to re-run the evaluation module 324 against the logical application 319. In one embodiment, the modification module 328 may make such a determination based on a user-configurable percentage of change in the logical application 319 between running iterations of the evaluation module 324. Alternatively, a user-configurable setting may determine a pre-defined number of iterations.

In this manner, the logical application 319 continues to grow or shrink based on relationships between recently added resources and resources already present in the logical application 319. Once the logical application 319 changes very little between iterations, the logical application may be said to be stable.

Once the modification module 328 determines that the logical application 319 is complete (stable or the required number of iterations have been completed), the determination module 306 provides the logical application 319 to the interface 308. Preferably, the interface 308 allows a user to interact with the logical application 319 using either a Graphical User Interface 332 (GUI) or an Application Programming Interface 334 (API).

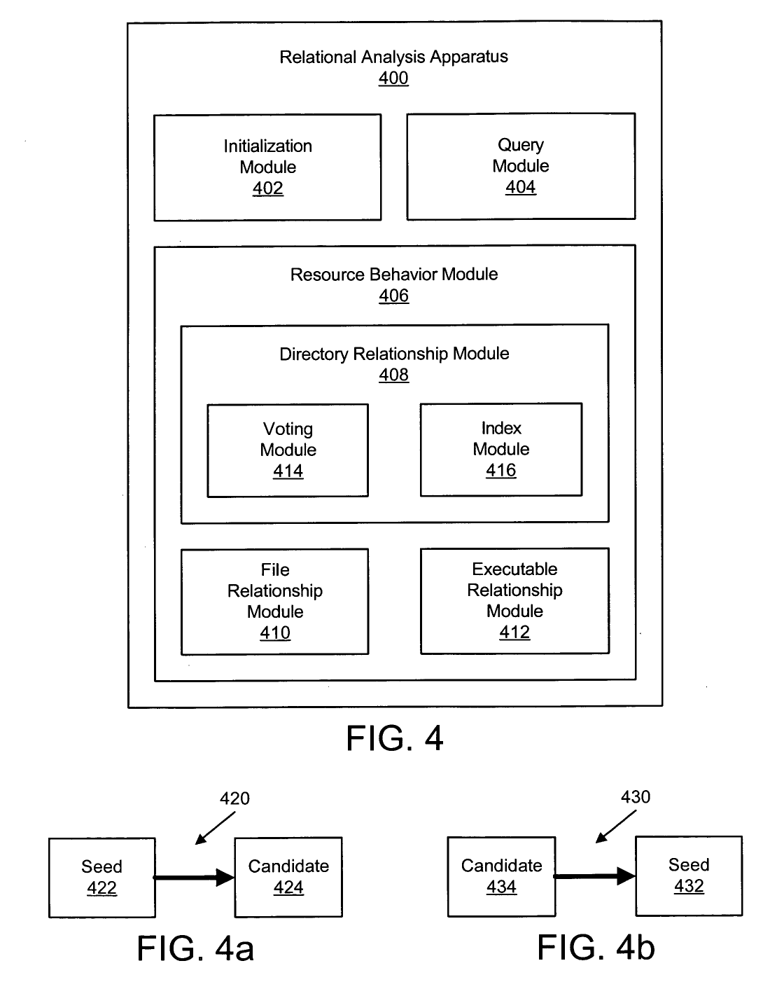

FIG. 4 depicts one embodiment of a relational analysis apparatus 400 given by way of example of the analysis module 304 of FIG. 3. The illustrated relational analysis apparatus 400 includes an initialization module 402, a query module 404, and a resource behavior module 406. While the relational analysis apparatus 400 may be employed to facilitate defining a logical application associated with a business process, certain embodiments of the present invention may be employed independently of a business process in order to establish an association between a seed identifier and one or more other system resources.

The initialization module 402, in one embodiment, is configured to receive a seed identifier, which identifies a seed resource, as described above. The query module 404, in one embodiment, is substantially similar to the query module 322 described in relation to FIG. 3. Among other functions, the query module 404 is configured to search the trace data 310 for system resources that may be related to the seed resource. In one embodiment, the query module 404 may search all of the trace data 310. Alternatively, the query module 404 may search only a subset of the trace data 310.

The resource behavior module 406 includes a directory relationship module 408, a file relationship module 410, and an executable relationship module 412. In one embodiment, the resource behavior module 406 is configured to select a candidate resource. A “candidate resource” is a system resource that is determined to possibly be associated with the seed resource based on a common resource event involving the seed resource and the candidate resource.

In particular, a “common resource event” includes any data operation or event recorded in the trace data 310 that involves the seed resource and an executable file, a data file, a directory, or any other system resource. For example, when the seed resource is an executable file, a common resource event may involve an executable or data file created, opened, or otherwise accessed by the seed resource. In a further embodiment, the common resource event may involve a directory in which the accessed file is located. In this case and with regard to the description herein, the directory is considered “accessed” when a file within the directory is created, modified, deleted, and so forth.

When a file or directory is accessed, the other files within that same directory may also be considered accessed or otherwise involved in a common resource event with the seed resource. Parent directories in which an accessed directory is located also may be considered to be involved in a common resource event. Other examples of common resource events will be provided below with reference to the directory relationship module 408, file relationship module 410, and executable relationship module 412.

The directory relationship module 408 is configured, in one embodiment, to determine if a directory is likely to be associated with the seed resource. The directory relationship module 408 may include a voting module 414 and an index module 416. In one embodiment, the directory relationship module 408 determines if a directory is a candidate resource by counting a number of directory accesses involving the seed resource and establishing an index to quantify the count.

For example, the directory relationship module 408 may employ the voting module 414 to increase an affirmative counter when a file in a given directory is accessed by an executable file that is the seed resource. In a further embodiment, the voting module 414 also may increase an affirmative counter corresponding to each parent directory and root the directory in which the accessed directory resides. In a similar manner, the voting module 414 may increase a negative counter when a file in a given directory is accessed by another resource that is not known to be related to the seed resource. Likewise, a negative counter for each parent and root directory also may be increased.

In this way, the voting module 414 may establish one or more counters for each directory that quantify the number of directory accesses by the seed resource or another related resource versus the number of directory accesses by an unrelated resource (a system resource not related to the seed resource). In an alternate embodiment, the voting module 414 may decrease the affirmative counter in response to an access by an unrelated resource, instead of maintaining a separate negative counter.

The index module 416 is configured, in one embodiment, to establish for each directory an index descriptive of the directory accesses of that directory related to the seed resource. In one embodiment, the index may simply be a ratio between the affirmative counter and the negative counter. In further embodiments, the index may be calculated using more complex algorithms, such as weighting directory access frequency, weighting parent directory accesses less heavily, and so forth.

The file relationship module 410 is configured, in one embodiment, to determine if a file is likely to be associated with the seed resource. In one embodiment, the file relationship module 410 determines if an executable or data file is a candidate resource based on which resource accesses the executable or data file. For example, if the seed resource is an executable, the file relationship module 410 may determine that each of the files (executable or data) accessed by the seed resource should be candidate resources.

FIG. 4a depicts one example of a file association relationship 420 in which a seed resource 422 accesses a candidate resource 424 (although not designated as a candidate until after the trace data 310 is analyzed). In this case, the candidate resource 422 is being accessed by the seed resource 422 or another related resource.

The functionality of the executable relationship module 412 is analogous to that of the file relationship module 410. The executable relationship module 410 is configured, in one embodiment, to determine that a candidate executable file is likely associated with the seed resource if the candidate executable file accesses the seed resource. For example, if the seed resource is an executable or data file, the executable relationship module 410 may determine that each of the executable files that accesses the seed resource should be candidate resources. Files already associated with the seed resource that are accessed by the candidate executable file are also identified by the executable relationship module 410.

FIG. 4b depicts one example of an executable association relationship 430 in which a seed resource 432 is accessed by a candidate resource 434 (although not designated as a candidate until after the trace data 310 is analyzed). In this case, the candidate resource 434 accesses the seed resource 432 or another related resource.

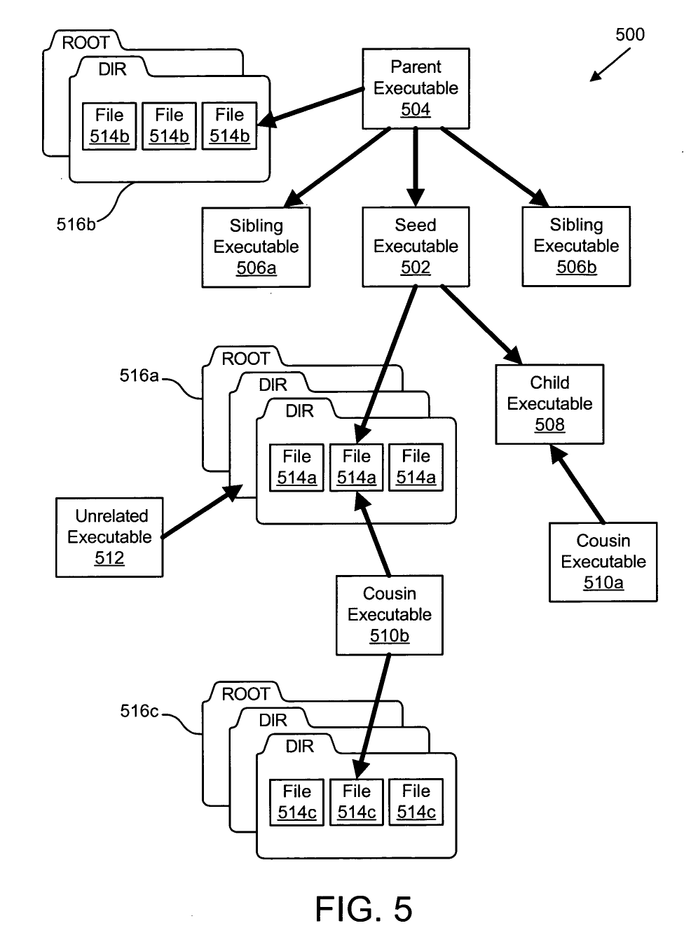

FIG. 5 depicts a resource relationship tree 500 that illustrates the several relationships described with reference to the directory relationship module 408, file relationship module 410, and executable relationship module 412 of FIG. 4. For clarity in describing the several resource relationships illustrated in the resource relationship tree 500, the present description employs the terms “parent,” “sibling,” “child,” “cousin,” and “unrelated” to describe the relationship between several executable files and a seed resource. This terminology is only employed for descriptive purposes to show relationships between the several system resources (directories, data files, and executable files) and is not meant to limit other implementations or relationships that might be recognized in various systems and scenarios.

The illustrated resource relationship tree 500 centers around a seed executable file 502, which serves as a seed resource in this case. In alternative embodiments, other types of system resources, such as data files, also may serve a seed resource. The seed executable file 502 is associated with several other executable files based on how the executable files are accessed in relation to the seed executable file 502. For example, a parent executable file 504 may access the seed executable file 502, as well as one or more sibling executable files 506a-b. In turn, the seed executable file 502 may access a child executable file 508. A cousin executable file 510a also may access a child executable file 508. An unrelated executable file 512 does not access and is not accessed by the seed executable file 502 and is otherwise not associated with the seed executable file 508.

In addition to accessing other executable files, the seed executable file 502 or another related or unrelated executable file may access data files 514a-c within one or more directories 516a-c. Several directories and subdirectories together may form a directory tree. The various executable files 502-512 also may reside in the same or similar directories 516a-c, but this relationship is not shown in FIG. 5 for clarity.

Referring to FIG. 5 and to the directory relationship module 408 of FIG. 4, the voting module 414 may increase an affirmative counter for each of the directories 516a in which a file 514a that is accessed by the seed executable file 502 resides. Similarly, affirmative counters corresponding to each of the directories 516b accessed by the parent executable file 504 and the directories 516c accessed by the cousin executable file 510b also may be incremented if the parent executable file 504 and the cousin executable file 510b are known to be related to the seed executable file 502.

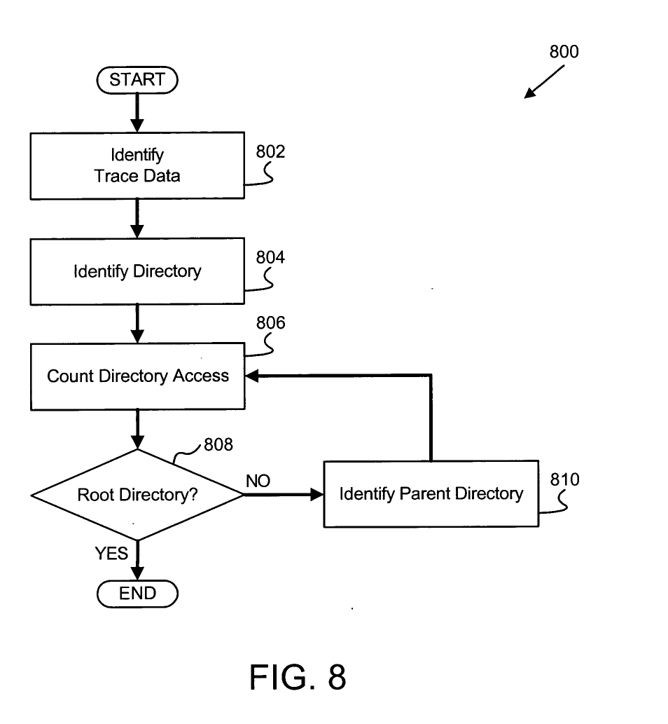

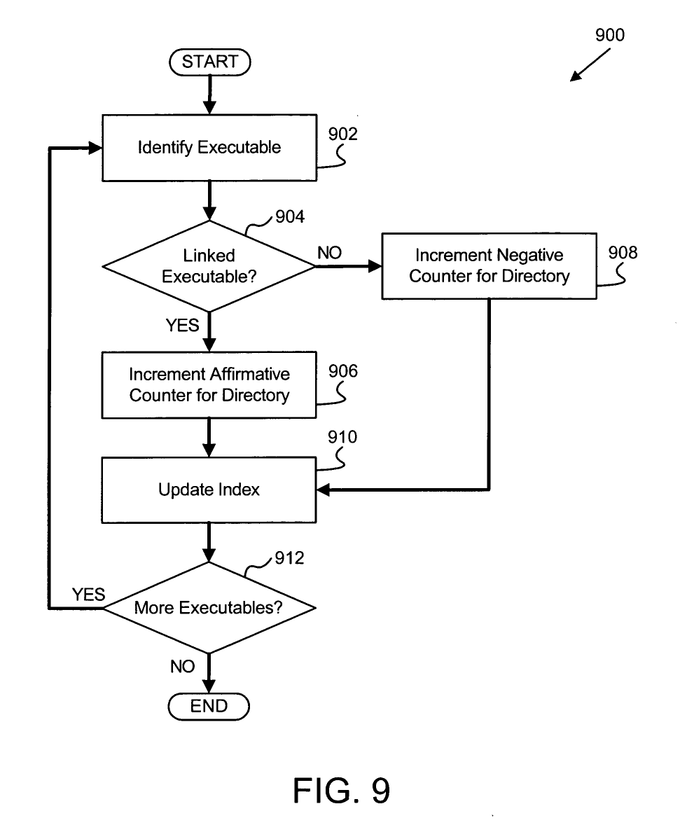

On the other hand, negative counters corresponding to the parent directory 516a (shown in the middle) and the root directory 516a may be incremented when it is. determined that the unrelated executable file 512 accesses a data file (not shown) in the parent directory, for example. In this way, directory accesses by related executable files 502-510 and unrelated executable files 512 are individually counted for each of the accessed, parent, and root directories 516a. The functionality of the directory relationship module 408 is described further with reference to FIGS. 8 and 9.

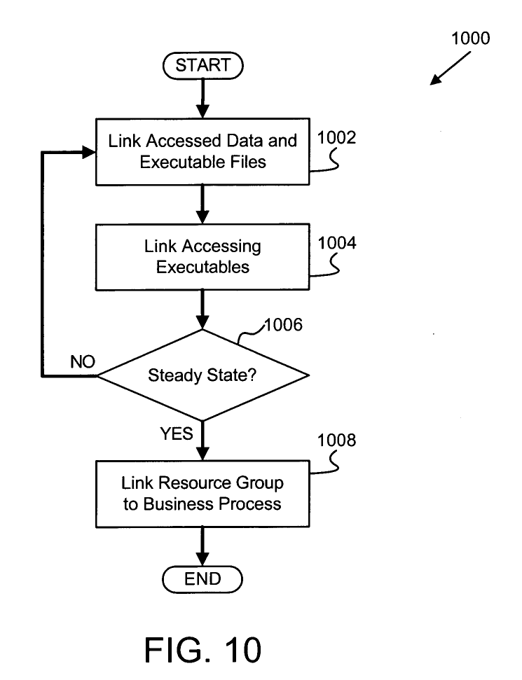

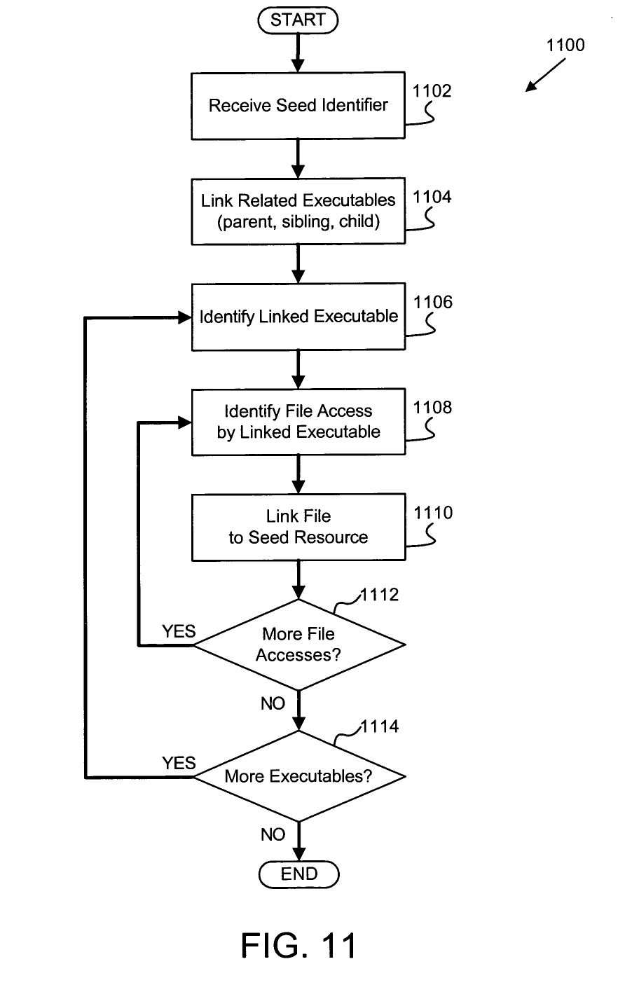

Referring still to FIG. 5 and to the file relationship module 410 of FIG. 4, the file relationship module 410 may be configured to track which executable and data files may be associated with the seed executable file 502 based on which executable and data files are accessed by the seed executable file 502 or a related executable file 504-510. For example, the child executable file 508 maybe designated as a candidate resource because it is accessed by the seed executable file 502. Likewise, the data file 514a accessed by the seed executable file 502 may be designated as a candidate resource. In a further embodiment, all of the data files 514a within the same accessed directory 516a also may be designated as candidate resources based on their logical proximity to the accessed data file 514a. The functionality of the file relationship module 410 is described further with reference to FIGS. 10 and 11.

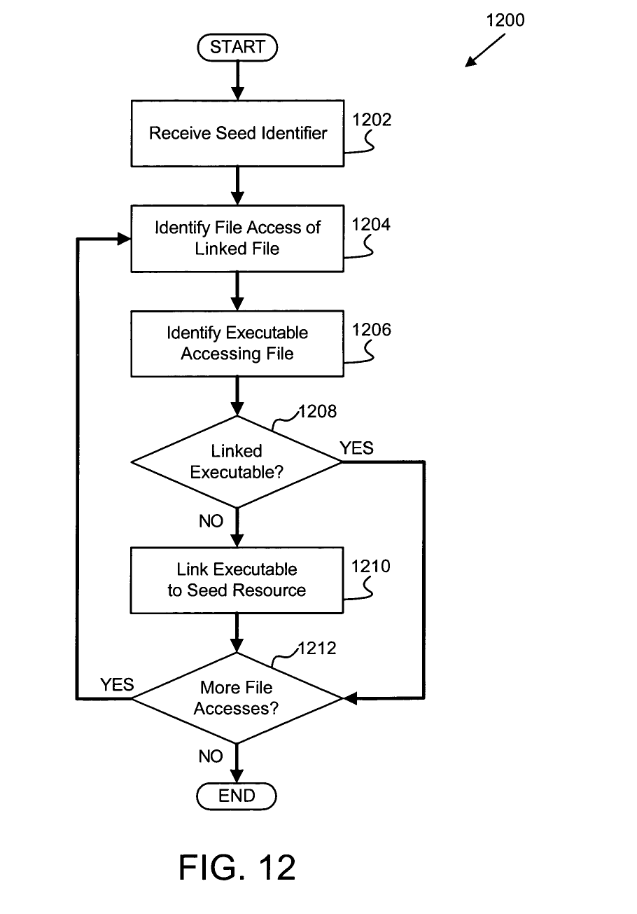

Referring still to FIGS. 4 and 5, the executable relationship module 412 may track which executable files may be associated with the seed executable file 502 based on which executable files access the seed executable file 502 or an executable or data file related to the seed executable file 502. For example, the parent executable file 504 may be designated as a candidate resource because it accesses the seed executable file 502. Likewise, the cousin executable file 510b may be designated as a candidate resource because it accesses the related child executable file 508 (assuming the child executable file 508 is known to be associated with the seed executable file 502). The functionality of the executable relationship module 512 is described further with reference to FIGS. 10 and 12.

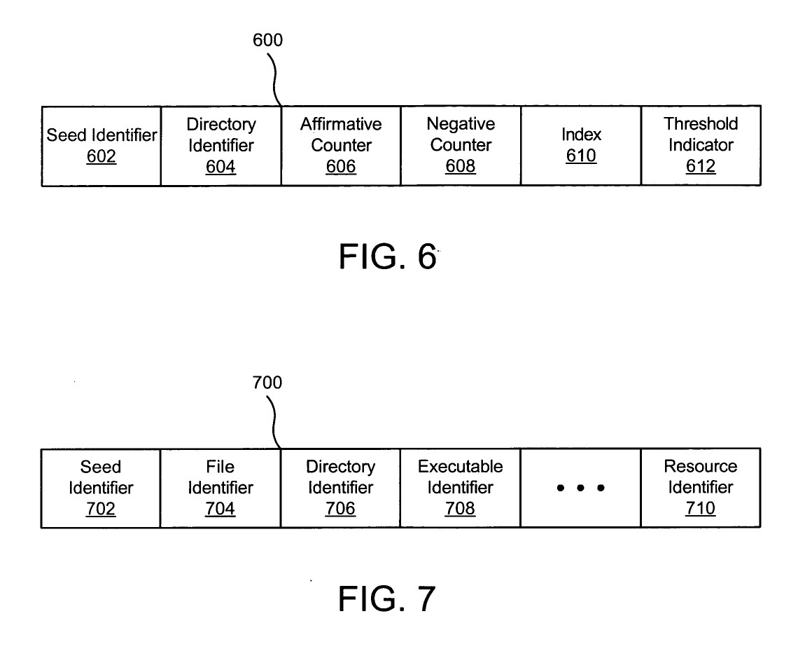

FIG. 6 depicts one embodiment of a directory voting record 600 that may be employed by the voting module 414 in order to count the affirmative and negative accesses of a directory 516. The illustrated voting record 600 includes a seed identifier 602, a directory identifier 604, an affirmative counter 606, a negative counter 608, an index 610, and a threshold indicator 612.

The seed identifier 602 identifies the seed resource. In one embodiment, the seed identifier is received from a user or a client application. The directory identifier 604 identifies a particular directory within the system. In one embodiment, an individual directory voting record 600 may be established for each seed/directory pair formed by a seed identifier 602 and a directory identifier 604.

The affirmative counter 606 is configured to track the number of directory accesses performed by the seed resource or by another resource associated with the seed resource. The negative counter 608 is configured to track the number of directory accesses performed by a resource that is not associated with the seed resource. In further embodiments, the directory voting record 600 may employ variations of the affirmative counter 606 and the negative counter 608, such as combining the counters or using additional counters of lesser or greater complexity. In one embodiment, the voting module 414 manages the affirmative counter 606 and negative counter 608.

The index 610 is established, in one embodiment, by the index module 416. As described above, the index 610 describes a relationship between a directory and a seed resource. In one embodiment, the index 610 may be a ratio between the affirmative counter 606 and the negative counter 608. In other embodiments, the index 610 may comprise a percentage of affirmative accesses to total accesses, or may employ weighted variables which may be defined by a user or client application.

The threshold indicator 612 identifies a threshold that may be used to compare against the index 610 and determine if the directory should be associated with the seed resource. For example, for a given directory, the affirmative counter 606 may be “12,” the negative counter may be “87,” and the resulting index 610 may be “12/87” or “14%.” If the threshold is “75%,” the directory would not be designated as a candidate resource because the index of “14%” fails to meet or exceed the minimum threshold of “75%.”

FIG. 7 depicts one embodiment of a resource group record 700 that may be used to identify a resource group. A “resource group” is a set of system resources that are determined to be associated with a given seed resource. In one embodiment, resource groups may define a single software application. Alternatively or in addition, a resource group may be used to define a logical application related to a business process. The illustrated resource group record 700 includes a seed identifier 702, a data file identifier 704, a directory identifier 706, an executable file identifier 708, and one or more additional resource identifiers 710.

The seed identifier 702 identifies the seed resource. The data file identifier 704 identifies a data file associated with the seed resource. Likewise, the directory identifier 706 identifies a directory associated with the seed resource. Similarly, the executable file identifier 708 identifies an executable file associated with the seed resource. Finally, the additional resource identifiers 710 identify other resources, including additional data files, executable files, directories, etc., that are associated with the seed resource. Although many different types of resources are shown associated with the seed resource in the illustrated resource group record 700, a particular resource group may comprise fewer or more types of system resources and a corresponding resource group record 700 may comprise fewer or more types of system resource identifiers 704-710.

FIG. 8 depicts one embodiment of a directory association method 800 that may be employed by the directory relationship module 408 of the resource behavior module 406. The illustrated directory association method 800 begins by identifying 802 the trace data 310, which may be stored in a central repository, for example. In one embodiment, the initialization module 402 may identify the trace data 310.

The query module 404 then, in one embodiment, identifies 804 a directory access recorded within the trace data 310. For each directory access, the directory relationship module 408 then counts 806 the directory access by updating the corresponding directory voting record 600. One example of counting 806 the directory access for a given directory is described in more detail with reference to FIG. 9.

After counting 806 the directory access, the directory relationship module 408 may determine 808 if the current directory is a root directory. If it is not a root directory, the directory relationship module 408 identifies 810 the parent directory and returns to count 806 the directory access for the parent directory. The directory association method 800 continues to count 806 each of the parent directories until all of the parent directories, including the root directory, have been counted 806. The directory association method 800 then ends.

FIG. 9 depicts one embodiment of a directory voting method 900 given by way of example of the counting step 806 of the directory association method 800 shown in FIG. 8. A resource associated with the seed resource also may be referred to as a “linked resource.” As used herein the seed resource also may be considered a linked resource as a seed resource is implicitly linked to itself.

For each directory access, the directory voting method 900 identifies 902 the executable file accessing the directory. The directory relationship module 408 then determines 904 if the executable file is a linked resource.

If the accessing executable file is a linked resource, the voting module 414 increments 906 the affirmative counter 606 in the voting record 600 for the given seed/directory pair, as described in relation to FIG. 6. Otherwise, the voting module 414 increments 908 the negative counter 608 in the corresponding voting record. After incrementing 906, 908 either the affirmative counter 606 or the negative counter 608, the index module 416 may update 910 the index 610 in the directory voting record 600. Alternately, the index module 416 may update 910 the index 610 on a schedule other than after every change to either of the counters 606, 608.

In the depicted embodiment, after updating 910 the index 610, the query module 404 may determine 912 if the same directory is accessed by another executable file and, if so, may iteratively return to identify 902 the next accessing executable file until all directory accesses for the given directory have been counted 806. The depicted directory voting method 900 then ends.

FIG. 10 depicts one embodiment of a file usage method 1000 that may be employed by the resource behavior module 406 in conjunction with the file relationship module 410 and the executable relationship module 412. The illustrated file usage method 1000 begins by linking 1002 executable and data files that are associated with the seed resource because they are accessed by a linked resource which may include the seed resource. In one embodiment, the file relationship module 410 links 1002 the accessed files to the seed resource within a resource group record 700. Linking 1002 accessed files is described in more detail with reference to FIG. 11.

The executable relationship module 412 then may link 1004 executable files that are associated with the seed resource because they access a linked resource. Linking 1004 executable files is described in more detail with reference to FIG. 12.

The relationship behavior module 406 may continue to alternate between linking 1002 files and linking 1004 executable files until the resource group record 700 is determined 1004 to reach a steady state. A steady state may be defined by a maximum threshold number of changes over consecutive linking iterations. In other words, if zero or very few (i.e. below a quantitative or percentage threshold) additional data files and executable files are linked 1002, 1004 in a single iteration, the resource group record 700 is determined 1006 to be in a steady state. In one embodiment, the resource group may be associated 1008 with a logical application and/or business process. The depicted file usage method 1000 then ends.

FIG. 11 depicts one embodiment of a file association method 1100 given by way of example of the file linking step 1002 of the file usage method 1000 shown in FIG. 10. The illustrated file association method 1100 begins by receiving 1102 a seed identifier to identify a seed resource. In one embodiment, the initialization module 402 receives 1102 the seed identifier.

The file association method 1100 continues by linking 1104 executable files that are related (i.e. parent, child, sibling, cousin, etc.) to the seed resource. In one embodiment, the file relationship module 410 may access an existing resource group record 700 to determine which executable files are linked to the seed resource. In another embodiment, the file relationship module 410 may invoke the executable relationship module 412 to determine at least some of the linked executable files.

The file relationship module 410, in one embodiment, then identifies 1106 one of the linked executable files. For each linked executable file, the query module 402, in one embodiment, may search the trace data 310 to identify 1108 a file access performed by the linked executable. When the query module identifies 1108 a file accessed by the linked executable, the file relationship module 410 then links 1110 the accessed file to the seed resource, for example by adding the corresponding file identifier 704 to the resource group record 700.

The query module 404 and the file relationship module 410 continue to identify 1108 and link 1110 accessed files until the query module 402, for example, determines 1112 that all of the files accessed by the linked executable file have been identified 1108. The file relationship module 410, in the depicted embodiment, then determines 1114 if more linked executable files need to be processed and, if so, may iteratively return to identify 1106 a subsequent linked executable file. The depicted file association method 1100 ends when the file relationship module 410 determines 1114 that all of the linked executable files have been processed.

FIG. 12 depicts one embodiment of an executable association method 1200 given by way of example of the executable file linking step 1004 of the file usage method 1000 shown in FIG. 10. The illustrated executable association method 1200 begins by receiving 1202 a seed identifier to identify a seed resource. In one embodiment, the initialization module 402 receives 1202 the seed identifier.

The executable association method 1200 continues by identifying 1204 a file access of a linked file. As described above, a linked file may be a data file or an executable file associated with the seed resource. In one embodiment, the executable relationship module 412 may access an existing resource group record 700 to determine which files are linked to the seed resource. In another embodiment, the executable relationship module 412 may invoke the file relationship module 410 to determine at least some of the linked files.

The executable relationship module 412, in one embodiment, then identifies 1206 the executable file that accessed the linked file and determines 1208 if the executable file is already linked to the seed resource. If the accessing executable file is not already linked, the executable relationship module 412 links 1210 the accessing executable file to the seed resource, such as by adding the corresponding executable file identifier 708 to the resource group record 700. Otherwise, if the accessing executable file is already linked, the executable relationship module 412 may do nothing.

The query module 404 then, in one embodiment, may determine 1212 if more linked files have been accessed. If so, the executable relationship module 412 continues to link 1208 the executable files accessing the accessed files until the query module 404, for example, determines 1212 that all of the linked files have been identified 1204. The depicted executable association method 1200 then ends.

Advantageously, the present invention in various embodiments facilitates automatically associating system resources, given a seed resource identifier and trace data describing a plurality of resource events. The present invention beneficially also uses behavior based algorithms to recognize certain relationships between the seed resource and one or more other resources.

In further embodiments, the present invention may be employed to either build up or whittle down a resource group. As explained above, building up a resource group allows only system resources that are known to be related to a seed resource to be added to the resource group. This results in a resource group in which all linked resources are confidently associated with the seed resource. The algorithms, modules, and methods described herein are conducive to a build-up scheme.

In contrast, whittling down a resource group includes all system resources except those known to be unrelated to the seed resource. This results in a more inclusive, but less confident, association between the linked resources and the seed resource. An inverse variation of the algorithms, modules, and methods described herein would be conducive to a whittle-down scheme.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to associate resources using a behavior based algorithm, the apparatus comprising:
an initialization module configured to receive a seed identifier corresponding to a seed resource, the seed resource comprising one of a plurality of system resources;
a query module configured to search trace data for a candidate resource, the trace data descriptive of a plurality of resource events among the plurality of system resources; and
a resource behavior module configured to select the candidate resource based on a common resource event involving the seed resource and the candidate resource.

2. The apparatus of claim 1, wherein the resource behavior module is further configured to link the candidate resource with the seed resource and to create a resource group, the resource group comprising the seed resource and the linked resource.

3. The apparatus of claim 1, wherein the resource behavior module further comprises a directory relationship module configured to determine if a directory is a candidate resource.

4. The apparatus of claim 3, wherein the directory relationship module comprises a voting module, the voting module configured to increase an affirmative counter in response to an access of the directory by an executable file linked with the seed resource.

5. The apparatus of claim 3, wherein the directory relationship module comprises a voting module, the voting module is configured to increase a negative counter in response to an access of the directory by an executable file not linked with the seed resource.

6. The apparatus of claim 3, wherein the directory relationship module comprises an index module configured to establish an index, the index based on a count from a counter and defining a directory access relationship between the directory and the seed resource.

7. The apparatus of claim 1, wherein the resource behavior module further comprises a file relationship module configured to determine if a file is a candidate resource.

8. The apparatus of claim 7, wherein the file relationship module is further configured to select the file as a candidate resource in response to an access of the file by an executable file linked with the seed resource.

9. The apparatus of claim 1, wherein the resource behavior module further comprises an executable relationship module configured to determine if an executable file is a candidate resource.

10. The apparatus of claim 9, wherein the executable relationship module is further configured to select the executable file as a candidate resource in response to an access of a linked file by the executable file.

11. The apparatus of claim 1, wherein the trace data is historical data descriptive of finalized resource events.

12. The apparatus of claim 1, wherein the trace data is dynamically updated in response to a current resource event.

13. The apparatus of claim 1, wherein the seed resource belongs to a business process, the business process defined by the seed resource and a plurality of linked resources.

14. A system to associate resources using a behavior based algorithm, the system comprising:
a monitor module configured to monitor a plurality of resource events among a plurality of system resources;
a storage device configured to store trace data, the trace data descriptive of the plurality of resource events;
an initialization module configured to receive a seed identifier from a user, the seed identifier corresponding to a seed resource, the seed resource comprising one of the plurality of system resources;
a query module configured to search the trace data for a candidate resource; and
a resource behavior module configured to select the candidate resource based on a common resource event involving the seed resource and the candidate resource.

15. The system of claim 14, wherein the resource behavior module is further configured to link the candidate resource with the seed resource.

16. The system of claim 14, further comprising a directory relationship module configured to link a directory with the seed resource and to assign the directory to a business process.

17. The system of claim 14, further comprising a file relationship module configured to link a file with the seed resource and to assign the file to a business process.

18. The system of claim 14, further comprising an executable relationship module configured to link an executable file with the seed resource and to assign the executable to a business process.

19. A signal bearing medium tangibly embodying a program of machine-readable instructions executable by a digital processing apparatus to perform operations to associate resources using a behavior based algorithm, the operations comprising:
receiving a seed identifier corresponding to a seed resource, the seed resource comprising one of a plurality of system resources;
searching trace data for a candidate resource, the trace data descriptive of a plurality of resource events among the plurality of system resources; and
selecting the candidate resource based on a common resource event involving the seed resource and the candidate resource.

20. The signal bearing medium of claim 19, wherein the instructions further comprise operations to link the candidate resource with the seed resource and create a resource group, the resource group comprising the seed resource and the linked resource.

21. The signal bearing medium of claim 19, wherein the instructions further comprise operations to determine if a directory is a candidate resource.

22. The signal bearing medium of claim 21, wherein the instructions further comprise operations to increase an affirmative counter in response to an access of the directory by an executable file linked with the seed resource.

23. The signal bearing medium of claim 21, wherein the instructions further comprise operations to increase a negative counter in response to an access of the directory by an executable file not linked with the seed resource.

24. The signal bearing medium of claim 19, wherein the instructions further comprise operations to establish an index, the index based on a count from a counter and defining a directory access relationship between the directory and the seed resource.

25. The signal bearing medium of claim 19, wherein the instructions further comprise operations to determine if a file is a candidate resource.

26. The signal bearing medium of claim 25, wherein the instructions further comprise operations to select the file as a candidate resource in response to an access of the file by an executable file linked with the seed resource.

27. The signal bearing medium of claim 19, wherein the instructions further comprise operations to determine if an executable file is a candidate resource.

28. The signal bearing medium of claim 27, wherein the instructions further comprise operations to select the executable file as a candidate resource in response to an access of a linked file by the executable file.

29. The signal bearing medium of claim 19, wherein the seed resource belongs to a business process, the business process defined by the seed resource and a plurality of linked resources.

30. A method for associating resources using ownership based algorithms, the method comprising:
receiving a seed identifier corresponding to a seed resource, the seed resource comprising one of a plurality of system resources;
searching trace data for a candidate resource, the trace data descriptive of a plurality of resource events among the plurality of system resources; and
selecting the candidate resource based on a common resource event involving the seed resource and the candidate resource.

31. An apparatus to associate resources using ownership based algorithms, the apparatus comprising:
means for receiving a seed identifier corresponding to a seed resource, the seed resource comprising one of a plurality of system resources;
means for searching trace data for a candidate resource, the trace data descriptive of a plurality of resource events among the plurality of system resources; and
means for selecting the candidate resource based on a common resource event involving the seed resource and the candidate resource.
